(19) United States
(12) Patent Application Publication
(10) Pub. No.: US 2007/0124965 A1
(43) Pub. Date: Jun. 7, 2007

(54) Visual identification system for preselected objects

(76) Inventors: Nichola C. McMurtry, La Conner, WA (US); Herbert McMurtry, La Conner, WA (US)

Correspondence Address: JAMES RAY & ASSOCIATES, 2640 PITCAIRN ROAD, MONROEVILLE, PA, 15146, US

(21) Appl. No.: 11/294,261

(22) Filed: Dec. 5, 2005

(51) Int. Cl. G09F 3/10

(52) U.S. Cl. 40/299.01

(57) ABSTRACT

An apparatus for visually displaying a preselected identification means for preselected objects. Such apparatus includes at least one preselected identification device having each of a predetermined shape and a predetermined size and at least one unique identifier selected from a group at least consisting of such predetermined shape of such at least one preselected identification device, school logos, photographs, colors, ribbons, children's themes and animals. Additionally, there is a mechanism engageable with each of the at least one preselected identification device and such preselected objects for securing the apparatus to such preselected objects.

### FIELD OF THE INVENTION

The present invention relates, in general, to preselected object identification and, more particularly, this invention relates to a visual identification system for various objects which can be personalized for individuals and, still more particularly, this invention relates to a prepackaged visual identification system based on a preselected theme.

### BACKGROUND OF THE INVENTION

There has always been a problem with being able to identify articles, such as luggage, backpacks, laptop computer cases and similar items that belong to an individual. This problem is compounded by the number of travelers in today's society. This is particularly true in travel situations such as the baggage claim area at most airports. It is difficult to quickly identify these items and retrieve the correct bag when faced with hundreds of similar items at a baggage carousel. Locking of luggage or laptop computers or other such items, at least prevents others from obtaining possible vital information from them; however, it does not aid in identifying such items.

Bags or other items which have distinctive labeling or with distinctive tracking systems attached thereto are easy to locate and, thus, makes retrieval of these items easy.

It would be advantageous for travelers today if their bags or other such items could be equipped with such distinctive identification means easily and inexpensively and thereby reduce the anxiety of finding the proper checked baggage at an airport or other travel means.

### SUMMARY OF THE INVENTION

In a first embodiment the present invention provides an apparatus for visually displaying a preselected identification means for preselected objects. Such apparatus includes at least one preselected identification means having each of a predetermined shape and a predetermined size and at least one unique identifier selected from a group at least consisting of such predetermined shape of such at least one preselected identification means, school logos, photographs, colors, ribbons, children's themes and animals. Additionally, there is a means engageable with each of the at least one preselected identification means and such preselected objects for securing the apparatus to such preselected objects.

In a second embodiment, the present invention provides a prepackaged visual identification device for readily identifying a user's personal items. Such prepackaged visual identification means includes a package and a first predetermined number of preselected identification means having each of a predetermined shape and a predetermined size and at least one unique identifier selected from a group at least consisting of such predetermined shape of such at least one preselected identification means, school logos, photographs, colors, ribbons, children's themes and animals disposed in the package. There is also a second predetermined number of means engageable with respective ones of such first predetermined number of such preselected identification means and such preselected objects for securing the identification means to such personal items.

### OBJECTS OF THE INVENTION

It is, therefore, one of the primary objects of the present invention to provide a visual identification system for locating baggage items such as luggage, laptop computers and other items.

Another object of the present invention is to provide a visual identification system that is easy to use.

Yet, another object of the present invention is to provide a visual identification system which will identify such baggage items by using colorful ribbons, distinctive laminated tags in school colors and logos, children's themes and other similar items.

Still another object of the present invention is to provide a visual identification system which can have a variety of shapes and designs.

It is another object of the present invention to provide a visual identification system which can include pre-packaged materials enabling users to build their own luggage identifiers.

Yet it is another object of the invention to provide a visual identification system which is relatively inexpensive to use.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a partial perspective view of a piece of luggage having a visual identification means disposed thereon according to an embodiment of the invention.

FIG. 2 is a partial perspective view of a piece of luggage having a different visual identification means disposed thereon according to an embodiment of the invention.

FIG. 3 is a partial perspective view of a piece of luggage having a different visual identification means disposed thereon according to an embodiment of the invention.

FIG. 4 is partial perspective view of a golf bag having a visual identification means disposed thereon according to an embodiment of the invention.

FIG. 5 is a bag with a variety of identification means disposed therein according to an alternate embodiment of the invention.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first embodiment the present invention provides an apparatus, generally designated 10, for visually displaying a preselected identification means for preselected objects. Such apparatus 10 includes at least one preselected identification means, generally designated 20, having each of a predetermined shape and a predetermined size and at least one unique identifier selected from a group at least consisting of such predetermined shape of such at least one preselected identification means 20, school logos, photographs, colors, ribbons, children's themes and animals. Additionally, there is a means, generally designated 30, engageable with each of the at least one preselected identification means 20 and such preselected objects for securing the apparatus 10 to such preselected objects. It is presently preferred that such means 30 for securing such apparatus 10 to such preselected object is removably secured to such object.

Illustrated in FIGS. 1-3 are three examples of bags having visual identification means disposed thereon. FIG. 1 shows a luggage article with a ribbon 2 used to identify such article. The ribbon is brightly colored so as to be easily seen. Such colors could be distinctive colors such as colors representing a given school or sports team.

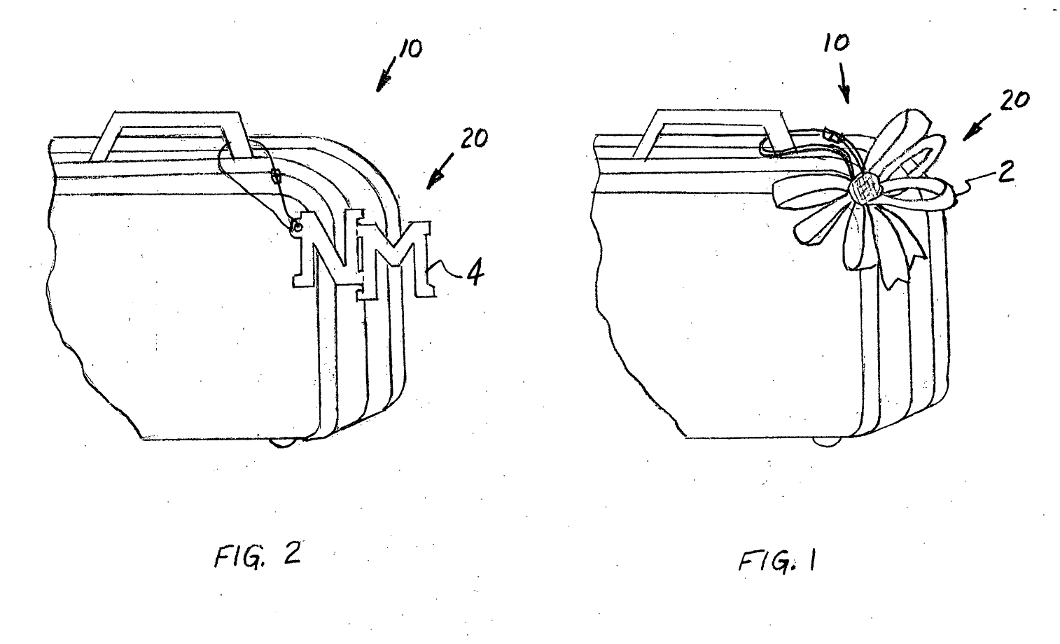

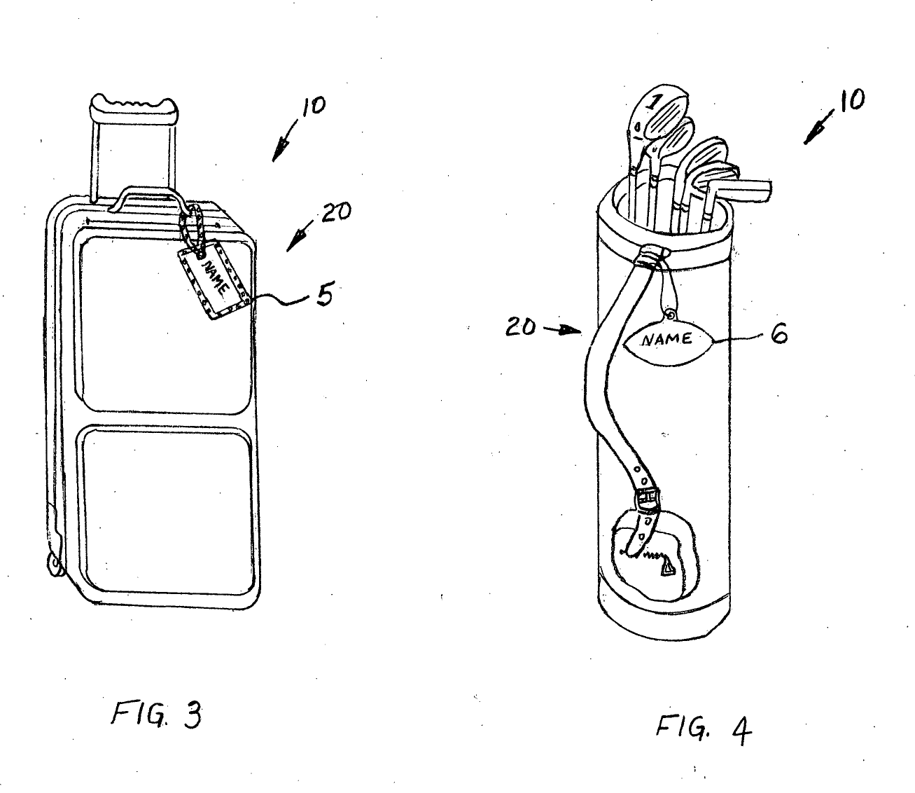

In FIGS. 2 and 3 there are other articles of luggage with a large set of initials 4 and a luggage tag 5 attached to the luggage. Again, such initials could represent the initials of the owner of such luggage or the initials could represent the initials of a favorite college (i.e. USC, BYU, ND, UCLA, UNC, etc.) and the luggage tag could have the owners name imprinted thereon. The initials or the tag could be made up in distinctive colors representing school colors or favorite colors of the owner. Such initials would be large enough that they could be spotted easily even on the baggage carousel of an airport.

FIG. 4 shows a golf bag having a visual identification means disposed thereon. In this instance such identification means is a tag in the shape of a football 6 with the owners name written thereon. Such football 6 or other sports article such as a basketball, soccer ball, baseball, hockey stick, baseball bat, golf club, lacrosse stick or other sports equipment can again be made up in distinctive colors representing school colors or favorite colors of the owner. It is also preferred that such colors are fluorescent.

In a second embodiment, the present invention provides a prepackaged visual identification device, generally designated 50, for readily identifying a user's personal items. Such prepackaged visual identification means 50 includes a package and a first predetermined number of preselected identification means, generally designated 60, having each of a predetermined shape and a predetermined size and at least one unique identifier selected from a group at least consisting of such predetermined shape of such at least one preselected identification means, school logos, photographs, colors, ribbons, children's themes and animals disposed in the package. There is also a second predetermined number of means, generally designated 70, engageable with respective ones of such first predetermined number of such preselected identification means 60 and such preselected objects for securing the identification means to such personal items. Such, second predetermined number of means 70 includes ties, straps, clips, belts, chain, pin and double sided tape.

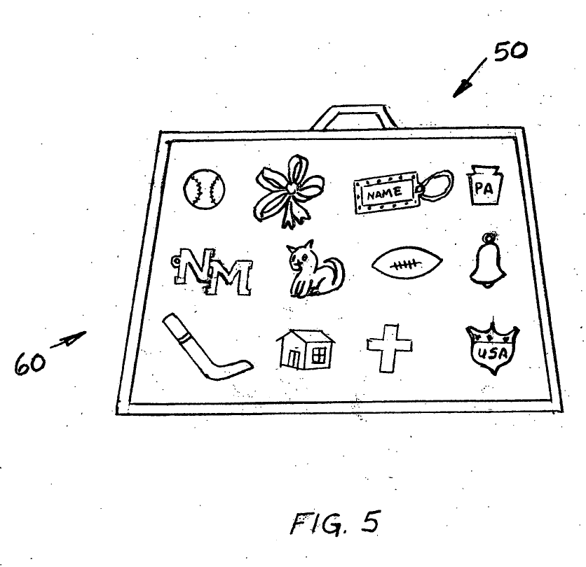

Illustrated in FIG. 5 is a bag containing a variety of identification means 60 disposed therein wherein the user can make or arrange their own identification item as they prefer.

In a preferred embodiment of the invention such first predetermined number of preselected identification means 60 and such second predetermined number of means 70 are the same. It is also preferred that such package be shrink wrapped.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. An apparatus for visually displaying a preselected identification means for preselected objects, said apparatus comprising:
(a) at least one preselected identification means having each of a predetermined shape and a predetermined size and at least one unique identifier selected from a group at least consisting of said predetermined shape of said at least one preselected identification means, school logos, photographs, colors, ribbons, children's themes and animals; and
(b) a means engageable with each of said at least one preselected identification means and such preselected objects for securing said apparatus to such preselected objects.

2. The apparatus, according to claim 1, wherein said means for securing said apparatus to such preselected objects includes means removably secured to such objects.

3. The apparatus, according to claim 1, wherein said preselected identification means is a ribbon.

4. The apparatus, according to claim 1, wherein said means for securing said apparatus to such preselected article is at least one of a tie, a strap, clip, belt, chain, pin and double faced adhesive.

5. The apparatus, according to claim 1, wherein said predetermined shape of said at least one preselected identification means is selected from a group consisting of sports equipment.

6. The apparatus, according to claim 5, wherein said sports equipment includes a football, soccer ball, basketball, baseball, baseball bat, golf club, lacrosse stick and a hockey stick.

7. The apparatus, according to claim 1, wherein said preselected identification means includes initials.

8. The apparatus, according to claim 7, wherein said initials have a distinctive color pattern.

9. The apparatus, according to claim 8, wherein said distinctive color pattern is selected from one of school colors and owners favorite colors.

10. The apparatus, according to claim 7, wherein said initials are selected from one of owners initials and a favorite college.

11. The apparatus, according to claim 8, wherein said distinctive color pattern is fluorescent.

12. The apparatus, according to claim 1, wherein said at least one unique identifier is a school logo.

13. A prepackaged visual identification device for readily identifying a user's personal items, said prepackaged visual identification means comprising:
(a) a package;
(b) a first predetermined number of preselected identification means having each of a predetermined shape and a predetermined size and at least one unique identifier selected from a group at least consisting of said predetermined shape of said at least one preselected identification means, school logos, photographs, colors, ribbons, children's themes and animals disposed in said package; and
(c) a second predetermined number of means engageable with respective ones of said first predetermined number of said preselected identification means and such preselected objects for securing said identification means to such personal items.

14. The prepackaged visual identification device, according to claim 13, wherein said first predetermined number of preselected identification means is a plurality of preselected identification means.

15. The prepackaged visual identification device, according to claim 13, wherein said first predetermined number of preselected identification means and said second predetermined number of means are identical.

16. The prepackaged visual identification device, according to claim 13, wherein said package is shrink wrapped.

17. The prepackaged visual identification device, according to claim 13, wherein said second predetermined number of means for securing said apparatus to such preselected article includes at least one of a tie, a strap, clip, belt, chain, pin and double faced adhesive.

18. The prepackaged visual identification device, according to claim 13, wherein said at least one unique identifier is selected from a group consisting of sports equipment.

19. The prepackaged visual identification device, according to claim 18, wherein said sports equipment includes a football, soccer ball, basketball, baseball, baseball bat, golf club, lacrosse stick and a hockey stick.

20. The prepackaged visual identification device, according to claim 13, wherein said colors are fluorescent.
